(19) United States
(12) Patent Application Publication
(10) Pub. No.: US 2016/0232839 A1
(43) Pub. Date: Aug. 11, 2016

(54) ELECTROLUMINESCENT STATUS DISPLAY

(71) Applicant: Symbolic IO Corporation, Holmdel, NJ (US)

(72) Inventor: Brian M. Ignomirello, Holmdel, NJ (US)

(21) Appl. No.: 14/700,597

(22) Filed: Apr. 30, 2015

Related U.S. Application Data
(60) Provisional application No. 62/114,023, filed on Feb. 9, 2015.

(51) Int. Cl. G09G 3/30; G09G 3/32

(52) U.S. Cl. CPC G09G 3/30; G09G 3/3233; G09G 2320/043; G09G 2300/0861; G09G 2320/0233

(57) ABSTRACT

System and method to provide an electroluminescent status display, the system including a sensor configured to detect a condition, a driver circuit to generate a control signal when the condition is detected by the sensor, and an electroluminescent display coupled to the driver circuit to receive the control signal, wherein the control signal controls light from the electroluminescent display. The method may include sensing a condition by use of a sensor, generating a control signal by use of a driver circuit when the condition is sensed by the sensor, and emitting electroluminescent light by use of an electroluminescent display coupled to the driver circuit, wherein the control signal controls emission of the electroluminescent light.

### CROSS-REFERENCE TO RELATED APPLICATIONS

This application claims the benefit of U.S. Provisional Patent Application Ser. No. 62/114,023, filed on Feb. 9, 2015, the entire content of which is hereby incorporated by reference in its entirety.

### BACKGROUND

Conventional status displays, e.g., for electronic equipment such as a computing or storage device, often include little more than one or more relatively small light-emitting diodes (LEDs), which may provide a binary status indicator (e.g., on/off, active/inactive, error/no error, etc.). Alternatively, a status display may include a somewhat larger liquid crystal display (LCD) or screen for status information, but an LCD display or screen is more expensive and is usually still relatively small compared to the equipment being monitored.

The relatively small size of such conventional status displays makes them hard to see, notice or interpret from a distance, e.g., from across an equipment room or at the end of a row of equipment racks or peering through windows into an equipment room. Abnormal conditions may not be noticed immediately, and may require a technician to inspect the status display at a closer distance (e.g., within five feet of the equipment). Furthermore, the relatively plain nature of the status display makes them appear to be relatively nondescript to a casual observer. Criticality of a critical alarm may be comprehended less quickly.

Therefore, what is needed is an improved status display that can help overcome the shortfalls of the conventional art.

### BRIEF SUMMARY

Embodiments in accordance with the present disclosure provide an improved equipment status display by use of one or more electroluminescent displays. Embodiments further include a system and method to use such an improved equipment status display.

Embodiments in accordance with the present disclosure provide a system to provide an electroluminescent status display, the system including a sensor configured to detect a condition, a driver circuit to generate a control signal when the condition is detected by the sensor, and an electroluminescent display coupled to the driver circuit to receive the control signal, wherein the control signal controls light from the electroluminescent display.

Embodiments in accordance with the present disclosure provide a method to provide an electroluminescent status display, the method including sensing a condition by use of a sensor, generating a control signal by use of a driver circuit when the condition is sensed by the sensor, and emitting electroluminescent light by use of an electroluminescent display coupled to the driver circuit, wherein the control signal controls emission of the electroluminescent light.

The preceding is a simplified summary of embodiments of the disclosure to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below.

### BRIEF DESCRIPTION OF THE DRAWINGS

The above and still further features and advantages of the present invention will become apparent upon consideration of the following detailed description of embodiments thereof, especially when taken in conjunction with the accompanying drawings wherein like reference numerals in the various figures are utilized to designate like components, and wherein:

FIG. 1 illustrates a schematic layer diagram of a conformal electroluminescent emitter as known in the art;

FIG. 2 illustrates a functional block diagram of an electroluminescent status display system in accordance with an embodiment of the present disclosure;

FIG. 3 illustrates a perspective view of a rack-mountable electronic equipment in accordance with an embodiment of the present disclosure; and

FIG. 4 illustrates a method in accordance with an embodiment of the present disclosure.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

In the following detailed description, numerous specific details are set forth in order to provide a thorough understanding of embodiments or other examples described herein. In some instances, well-known methods, procedures, components and circuits have not been described in detail, so as to not obscure the following description. Further, the examples disclosed are for exemplary purposes only and other examples may be employed in lieu of, or in combination with, the examples disclosed. It should also be noted the examples presented herein should not be construed as limiting of the scope of embodiments of the present invention, as other equally effective examples are possible and likely.

As used herein, the term “module” refers generally to a logical sequence or association of steps, processes or components. For example, a software module may comprise a set of associated routines or subroutines within a computer program. Alternatively, a module may comprise a substantially self-contained hardware device. A module may also comprise a logical set of processes irrespective of any software or hardware implementation.

Electroluminescence (EL) is a known characteristic of certain materials that enables the material to emit light in response to an electrical field. Electroluminescent light may have a relatively vibrant and uniform color that is difficult to achieve by other lighting technologies such as LED backlighting. Electroluminescent displays may also be very thin, thus being amenable to low-profile applications (i.e., thin applications) and flexible applications. Electroluminescent displays are also known to have very fast transition times, and appear to a human to turn on or off instantaneously.

At a sub-atomic level, electroluminescence is caused by radiative recombination, also known as spontaneous emission. During radiative recombination, an applied alternating electrical current causes phosphorescent substances to emit photons. EL does not require heat to produce light, meaning that an electroluminescent apparatus is safe, efficient, long lasting, and cool to the touch.

Embodiments in accordance with the present disclosure use one or more EL displays to help overcome shortfalls in the background art of equipment status displays, and provide an improved equipment status display. For example, an electroluminescent display allows for embodiments having a relatively larger size of status display compared to the conventional art. Such embodiments would be easier and quicker to see, notice or interpret from a distance, e.g., from across an equipment room or at the end of a row of equipment racks or peering through windows into an equipment room. Abnormal conditions would be noticed more quickly, without necessarily needing a technician to inspect the status display at a closer distance. Furthermore, the relatively eye-catching nature of the status display makes them appear to be highly noticeable to an observer, technician, or the like. Criticality of a critical alarm may be comprehended more quickly.

If lights within an equipment room have been dimmed, e.g., to save energy, an electroluminescent display may provide improved visibility in a dimly-lit space.

An electroluminescent apparatus as known in the art may be formed by applying various layers of materials as conformal coatings to an object by use of processes known in the art. For example, an electrically conductive base backplane film layer is applied upon a substrate. A dielectric film layer is applied upon the backplane film layer, then a phosphor film layer is applied upon the dielectric film layer. An electrode film layer is applied upon the phosphor film layer using a substantially transparent, electrically conductive material. An electrically conductive bus bar may be applied upon the electrode film layer. A spray conformal coating process may be used to apply at least some of the layers. The electroluminescent phosphor is excitable by an electrical field established across the phosphor film layer such that the device emits electroluminescent light upon application of an electrical charge between the backplane film layer and at least one of the electrode film layer and the bus bar.

Embodiments in accordance with the present disclosure may provide both functional and aesthetic benefits by use of a conformal coating electroluminescent display. For example, a conformal coating electroluminescent display may be formed or shaped in an arbitrary shapes (e.g., to reproduce a symbol or graphic such as a trademarked logo), thus providing an aesthetic benefit in addition to a functional benefit.

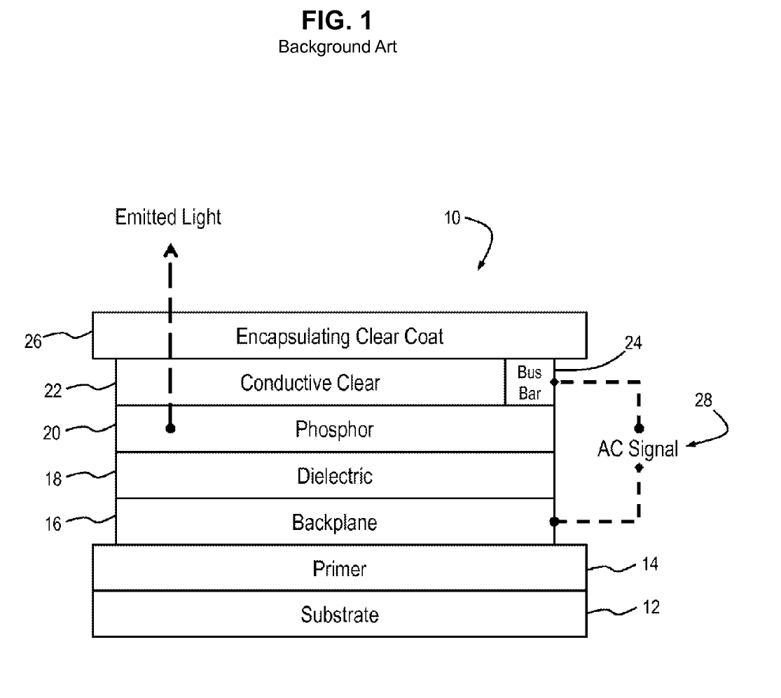

FIG. 1 illustrates a schematic layer diagram of an electroluminescent emitter 10 as known in the art. EL emitter 10 may include a substrate 12, a primer layer 14, an electrically conductive backplane electrode layer 16, a dielectric layer 18, a phosphor layer 20, a substantially transparent, electrically conductive top electrode 22, a bus bar 24 and an optional encapsulating layer 26.

Substrate 12 may be a select surface of any suitable target item upon which EL emitter 10 is to be applied. Substrate 12 may be conductive or non-conductive, and may have any desired combination of convex, concave and reflexed surfaces.

Primer layer 14 is a non-conductive film coating applied to substrate 12. Primer layer 14 serves to electrically insulate substrate 12 from subsequent conductive and semi-conductive layers, discussed further below. Primer layer 14 also preferably promotes adhesion between substrate 12 and subsequent layers.

Conductive backplane 16 is a film coating layer that is preferably masked over primer layer 14 to form a bottom electrode of EL emitter 10.

Dielectric layer 18 is an electrically non-conductive film coating layer comprising a material possessing high dielectric constant properties encapsulated within an insulating polymer matrix having relatively high permittivity characteristics (i.e., an index of a given material's ability to transmit an electromagnetic field). Dielectric layer 18 serves two functions. Firstly, dielectric layer 18 provides an insulating barrier between backplane layer 16 and the superimposed semi-conductive phosphor 20, top electrode 22 and bus bar 24 layers. In addition, because of the unique electromagnetic polarization characteristics of the dielectric materials, dielectric layer 18 serves to enhance the performance of the electromagnetic field generated between the backplane 16 and top electrode 22 layers when an alternating current (AC) signal 28 is applied between the backplane and the top electrode.

Phosphor layer 20 is a semi-conductive film coating layer comprised of a material (e.g., metal-doped Zinc Sulfide (ZnS)) encapsulated within a highly electrostatically permeable polymer matrix. When excited by the presence of an alternating electrostatic field generated by AC signal 28, the doped ZnS absorbs energy from the field, which it in turn re-emits as a visible-light photon upon returning to its ground state.

Top electrode 22 is a film coating layer that is preferably both electrically conductive and generally transparent to light.

Bus bar 24 provides a relatively low-impedance strip of conductive material, usually comprised of one or more of the materials usable to produce as conductive backplane 16. Bus bar 24 is typically applied to the peripheral edge of the lit field.

Encapsulating layer 26 is preferably an electrically insulating material applied over the EL emitter 10 stack-up, thereby protecting EL emitter 10 from external damage. Encapsulating layer 26 is also preferably generally transparent to light emitted by the lower layers of EL emitter 10, and is preferably chemically compatible with any envisioned topcoating materials for the target item of substrate 12 that provide a mechanism for chemical and/or mechanical bonding with topcoating layers. Encapsulating layer 26 may be comprised of any number of aqueous, enamel or lacquer-based products.

Embodiments in accordance with the present disclosure provide a relatively large EL display on a visible major surface of an electronic equipment. A visible surface includes a surface that would be visible during normal use. For example, if the electronic equipment is a rack-mounted computing or storage module having a visible major surface in a front direction of the rack, an EL display may be provided at least on the front surface of the module. Alternatively, the EL display may be provided on the rack itself, e.g., on a surface near the top of the rack, or on a portion of the rack adjacent to the side of the electronic equipment.

The EL display may be relatively large compared to display indicators of the known art, and/or compared to the size of the visible major surface. For example, the EL display may cover substantially the entire visible major surface, or more that a predetermined percentage of the major surface (e.g., more than 50%, more than 75%, more than 90%, etc.). More than one EL display may be used to cover the visible major surface, in order to provide separate status indicators. If more than one EL display is disposed on the visible major surface, a small portion of the visible major surface between adjacent EL displays may not be covered by one or more layers of the EL displays, forming gaps in those layers between adjacent EL displays. For example, a gap may exist in top electrode layer 22 in order to provide electrical isolation between adjacent EL displays. On the other hand, other layers such as primer layer 14 may extend across the entire visible major surface, including locations between adjacent EL displays.

Embodiments in accordance with the present disclosure may allow electronic equipment such as a computer system or a component thereof to provide quick visual identification of a condition (e.g., an error condition that warrants further attention, or a healthy condition that does not require immediate attention). The condition may be reflective of the status of a hardware component such as a circuit board (e.g., overheating, power supply failure, excessive CPU usage, etc.), or of a computer object (e.g., an anomalous state in a finite-state machine such as an intrusion detection, an anomalous state of data such as over-limit or under-limit conditions, and so forth). More generally, the condition may be indicative of hardware and/or software and/or an object-oriented representation of a portion of the system, and may be indicative of a degree of criticality (e.g., critical, warning and healthy).

In contrast to status indicators of the known art that use a small LED to act as an indicator of system status, embodiments in accordance with the present disclosure allow light and color alteration or morphing of, but not limited to, the entire front of a system. Embodiments may further indicate status by modulation of the electroluminescent display, e.g., by blinking an EL display on/off, or bright/dim, change colors, etc.

Embodiments in accordance with the present disclosure provide an additional benefit by providing enhanced aesthetics to cover the look of a computer or computer object.

An EL display may be applied to electronic equipment in a variety of ways. For example, an entire front-facing bezel (and potential other areas) of a system may have applied thereupon a single or multi-layer EL coating, while obtaining electrode power from but not limited to the computer system board (e.g., motherboard), system power supply, or alternate power sources in order to enable proper illumination and color transitioning. During certain events, the illuminated area or areas may morph on/off or change color.

Alternatively, if it desired to provide multiple colors to indicate multiple conditions (e.g., green, yellow and red to indicate good, marginal and failure, respectively), separate EL displays on separate portions of the major surface may be provided. Furthermore, because of the relatively larger size affordable by EL displays, the shape of the EL display itself may also be adapted to help indicate the type of condition to be indicated. For example, a red EL display to indicate a critical condition may be shaped like an octagon order to suggest a stop sign. In other examples, an entire front of a system can glow a red color, thus making the system very noticeable and identifiable in a large data center.

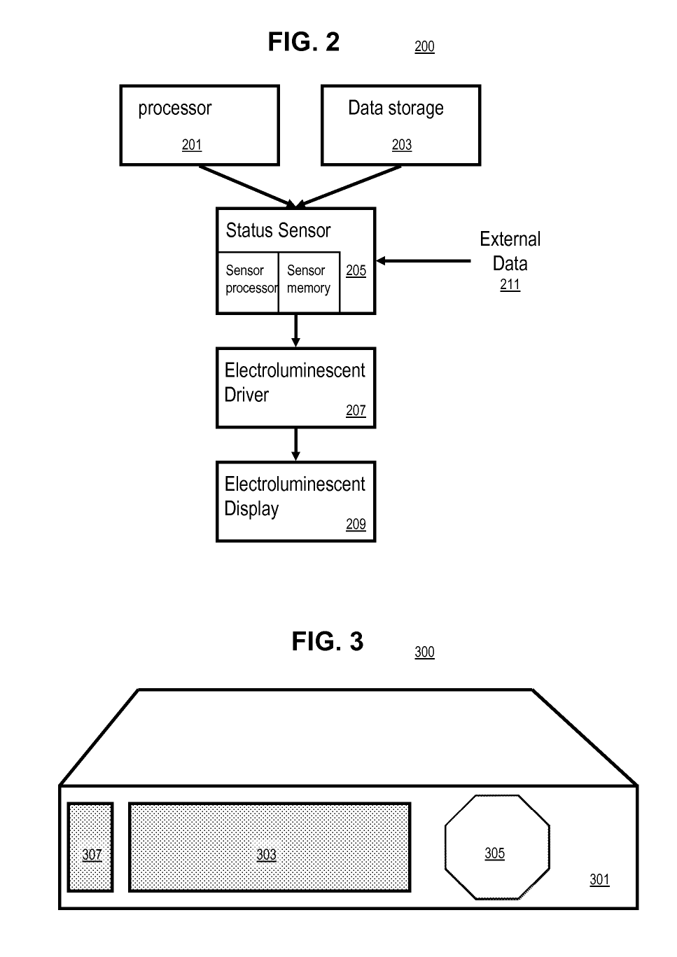

FIG. 2 illustrates a functional block diagram of an EL display system 200 in accordance with an embodiment of the present disclosure. System 200 includes electronic equipment such as processor 201 or data storage device 203, which are being monitored by status sensor 205. Additional electronic equipment or components thereof (not illustrated in FIG. 2) may be monitored, such as transceivers, power supplies, and so forth. Status sensors 205 may sense and report error conditions or lack of error conditions. Error conditions may include hardware errors (e.g., power supply failure, hot spots, over-voltage or under-voltage conditions, etc.), or software errors (e.g., fault conditions such as stack or buffer overflows, timeout or race conditions, high system resource utilization, etc.), or other errors (e.g., anomalous finite-state machine state), or any combination of such errors.

Status sensor 205 may include one or more of a hardware-type sensor, a software-based sensor, or an environmental sensor. Examples of hardware-type sensors may include a thermistor for an over-temperature monitor, a fan failure sensor, an over-voltage or under-voltage sensor, etc. Examples of a software-based sensor may include a watchdog timer, a monitoring daemon, an operating system task manager monitor, etc. Examples of an environmental sensor may include an ambient temperature or humidity monitor, a moisture sensor, a vibration sensor, etc.

Status sensor 205 may further include a sensor processor and a sensor memory to support sensing function or obtaining sensor readings. For example, if a polling process is used to gather readings from sensors, the sensor processor may be used to control the polling and the sensor memory may be used to store polled readings. Similarly, if an interrupt-driven process is used, the sensor processor may be used to respond to and handle an interrupt request.

Optionally, status sensor 205 may also be responsive to an external data signal 211 from an external source. For example, if a central monitoring center or operations center determines that an electronic equipment needs attention, a signal may be sent to status sensor 205 associated with the electronic equipment. In that circumstance, status sensor 205 would detect the presence of external data signal 211 and then cause an EL display on the electronic equipment to change state.

Status sensor 205 changes state when a monitored condition occurs or when in response to external data signal 211. A change of state may be indicated by, e.g., lighting up if normally off, turning off if normally on, changing color or intensity, or changing some other visible aspect such as blinking if not normally blinking, and so forth.

Status sensor 205 may be coupled to EL driver 207, which may accept logical control signals from status sensor 205 (e.g., whether or not an error condition exists) and generate hardware signals to drive one or more EL displays 209. Hardware signals may include lines of appropriate voltage and frequency to drive EL display 209 (e.g., the AC signal 28 of FIG. 1). EL display 209 may be disposed on a surface of the electronic equipment in order to provide the desired functionality and aesthetic design. A dedicated EL driver 207 may be provided for each EL display 209 that is to be controlled independently. For an EL display 209 capable of being on or off, being “on” may be considered to be an active state of EL display 209.

Multiple status sensors 205 may be provided, e.g., a dedicated sensor for at least some monitored conditions. However, when driving EL driver 207, at least some sensory conditions may be mapped (i.e., combined) in order to drive a single EL display 209. For example, all hardware faults may be combined to drive a single EL display 209 that represents the presence of any of the monitored hardware faults. Such mappings may be static, or may be provisionable by the sensor processor.

FIG. 3 illustrates a perspective view of a rack-mountable electronic equipment 300 in accordance with an embodiment of the present disclosure. Electronic equipment 300 includes a major front surface 301, which has disposed thereupon EL displays 303, 305. EL displays 303, 305 may be formed from the conformal electroluminescent emitter of FIG. 1. Major front surface 301 may be used as substrate 12 for EL displays 303, 305.

EL displays 303, 305 may provide different colors to provide indication of different conditions. For example, EL display 303 may be green when lit to provide an indication of good status, and EL display 305 may be red when lit to provide an indication of an error status. Shapes of EL displays 303, 305 may be selected to provide a desired aesthetic or functionality. For example, EL display 305 may be shaped functionally like a stop sign to indicate an error condition. EL display 303 may have a different shape, such as a shape that evokes function (e.g., a shape like a disk drive to indicate a state of health of a storage system) (not illustrated), or may have a fanciful shape such as a name or logo of a manufacturer, or a decorative shape. EL display 305 may be shaped aesthetically like a logo of the manufacturer of electronic equipment 300 or a component within (e.g., “SymbolicIO™ inside”). EL display 305 also may have dual purposes of functionality and aesthetics.

Electronic equipment 300 may further include an optional set of status or controls 307 for any information that cannot be easily conveyed by EL displays 303, 305 (for example, if any textual information such as a port number needs to be indicated).

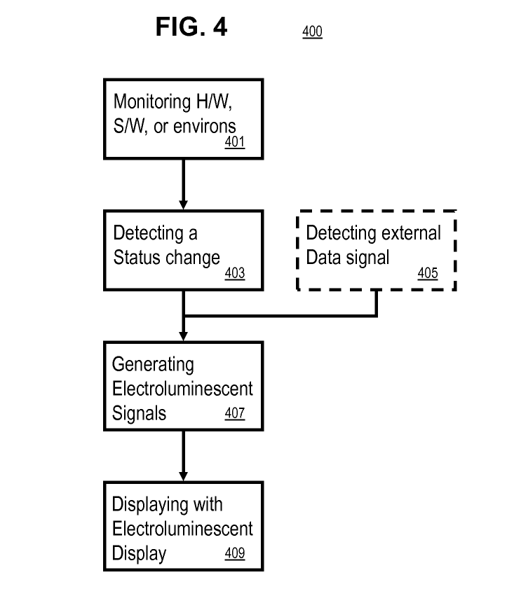

FIG. 4 illustrates a method 400 in accordance with an embodiment of the present disclosure. Method 400 begins at step 401, at which monitoring of hardware, software, and/or the environment takes place. Step 401, once it commences, is ordinarily an ongoing and/or substantially continuous process that may continue indefinitely. This may include a polling process or an interrupt-driven process.

Next, method 400 transitions to step 403, at which a change in status is detected. Until a change in status has in fact been detected (except for a control signal as described below), method 400 may remain in step 401. Step 403 may further include detecting what kind or type of monitored status has changed, e.g., a hardware status, a software status, or an environmental status. The change in status may represent a binary change in status (e.g., above a threshold or below a threshold), or alternatively a change in status may represent a change in a monitored analog or multilevel (greater than two levels) parameter (e.g., a temperature change). The magnitude of the change in the analog or multilevel parameter may be compared to a threshold by use of the sensor processor. For example, a 5 degree change in temperature may not be sufficient to raise an alarm, but a 20 degree change may be sufficient to raise an alarm.

Next, method 400 transitions to step 407, at which driving signals (e.g., AC signal 28) for an electroluminescent status display may be generated. Status may be indicated by a change in the driving signals, e.g., activate driving signals to indicate the start of a monitored status condition, or deactivating driving signal to indicate the end of a monitored status condition. Fault conditions may be mapped (i.e., combined) to drive a lesser number of EL displays. For example, all fault conditions may be mapped to one EL driver for hardware faults and one EL driver for software faults.

Optionally, method 400 may include step 405, at which an external data signal (e.g., external data signal 211) may be detected. The external data signal may be a signal that is intended to cause or stimulate a change in status of an EL display.

Next, method 400 transitions to step 409, at which an EL status display is changed, based upon the EL driving signals from step 407.

While the foregoing is directed to embodiments of the present invention, other and further embodiments of the present invention may be devised without departing from the basic scope thereof. It is understood that various embodiments described herein may be utilized in combination with any other embodiment described, without departing from the scope contained herein. Further, the foregoing description is not intended to be exhaustive or to limit the invention to the precise form disclosed. Modifications and variations are possible in light of the above teachings or may be acquired from practice of the invention. Certain exemplary embodiments may be identified by use of an open-ended list that includes wording to indicate that the list items are representative of the embodiments and that the list is not intended to represent a closed list exclusive of further embodiments. Such wording may include “e.g.,” “etc.,” “such as,” “for example,” “and so forth,” “and the like,” etc., and other wording as will be apparent from the surrounding context.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of” multiples of the items and/or the categories of items, individually or in conjunction with other items and/or other categories of items.

Moreover, the claims should not be read as limited to the described order or elements unless stated to that effect. In addition, use of the term “means” in any claim is intended to invoke 35 U.S.C. §112, ¶6, and any claim without the word “means” is not so intended.

1. A status display system, comprising:
a sensor configured to detect a condition;
a driver circuit to generate a control signal when the condition is detected by the sensor; and
a phosphor-based electroluminescent display coupled to the driver circuit to receive the control signal, wherein the control signal excites a phosphor to generate light from the electroluminescent display,
wherein the electroluminescent display comprises a conformal coating on a visible major surface of a monitored electronic equipment, wherein the electronic equipment is monitored by the sensor.

2. The system of claim 1, wherein the condition detected by the sensor comprises a hardware status of a monitored electronic equipment.

3. The system of claim 1, wherein the condition detected by the sensor comprises a software status of a monitored electronic equipment.

4. The system of claim 1, wherein the condition detected by the sensor comprises an environmental status.

5. The system of claim 1, wherein the condition detected by the sensor comprises presence of an external data signal.

6. The system of claim 1, wherein the driver circuit comprises a processor to compare the condition to a threshold level.

7. The system of claim 1, wherein the driver circuit is configured to generate a control signal when the condition changes by at least a threshold amount.

8. The system of claim 1, wherein the electroluminescent display comprises a conformal display on a visible major surface of a monitored electronic equipment, wherein the electronic equipment is monitored by the sensor.

9. The system of claim 8, wherein a shape of the electroluminescent display indicates a meaning of the detected condition when the electroluminescent display is active.

10. A method to display a status, comprising:
sensing a condition by use of a sensor;
generating a control signal by use of a driver circuit when the condition is sensed by the sensor; and
emitting electroluminescent light by use of a phosphor-based electroluminescent display coupled to the driver circuit, wherein the control signal excites a phosphor to generate emission of the electroluminescent light,
wherein the electroluminescent display comprises a conformal coating on a visible major surface of a monitored electronic equipment, wherein the electronic equipment is monitored by the sensor.

11. The method of claim 10, wherein the condition detected by the sensor comprises a hardware status of a monitored electronic equipment.

12. The method of claim 10, wherein the condition detected by the sensor comprises a software status of a monitored electronic equipment.

13. The method of claim 10, wherein the condition detected by the sensor comprises an environmental status.

14. The method of claim 10, wherein the condition detected by the sensor comprises presence of an external data signal.

15. The method of claim 10, wherein the driver circuit comprises a processor to compare the condition to a threshold level.

16. The method of claim 10, wherein the driver circuit is configured to generate a control signal when the condition changes by at least a threshold amount.

17. The method of claim 10, wherein the electroluminescent display comprises a conformal display on a visible major surface of a monitored electronic equipment, wherein the electronic equipment is monitored by the sensor.

18. The method of claim 17, wherein a shape of the electroluminescent display indicates a meaning of the detected condition when the electroluminescent display is active.

19. The system of claim 1, wherein the control signal comprises an alternating current (AC) signal.

20. The system of claim 1, wherein the electroluminescent display comprises a conformal phosphor coating on a visible major surface of a monitored electronic equipment, wherein the electronic equipment is monitored by the sensor.

21. The system of claim 1, wherein the electroluminescent display comprises a non-removable conformal coating on a visible major surface of a monitored electronic equipment, wherein the electronic equipment is monitored by the sensor.
